(19) United States
(12) Patent Application Publication
(10) Pub. No.: US 2011/0240129 A1
(43) Pub. Date: Oct. 6, 2011

(54) THICKENER FLOCCUANT CONTROL BY IN-SITU AGGREGATE SIZE ANALYSIS

(75) Inventor: Frederick Rinehart Schoenbrunn, Cottonwood Heights, UT (US)

(73) Assignee: FLSMIDTH A/S, Valby (DK)

(21) Appl. No.: 12/752,257

(22) Filed: Apr. 1, 2010

(51) Int. Cl. H04N 7/18; F17D 3/00

(52) U.S. Cl. 137/2; 348/135; 348/E07.091

(57) ABSTRACT

A system for performing in-situ aggregate size analysis in a feedwell assembly, which includes a feedwell assembly, which receives an influent feed stream from at least one feed pipe, and at least one flocculant feed pipe within the feed stream or feedwell assembly, which delivers a flocculant to the feed stream. An in-situ device provides images of flocculated particles within the feedwell assembly to an image analysis software application. The image analysis software application receives the images of the flocculated particles within the feedwell assembly and provides for size measurement and averaging for dosage control of the flocculant added to the influent feed stream within the feedwell assembly.

### FIELD OF THE INVENTION

This application relates generally to feedwells for flocculating and dispensing an influent slurry feed stream into a settling tank or basin, and more specifically to a feedwell for diluting and dispensing an influent slurry feed stream into a thickener, clarifier, or settling tank using a submersible camera to obtain streaming images of flocculated particles in the feedwell, and wherein the images are analyzed for particle size, which information can be used for control of the flocculant rate.

### BACKGROUND OF THE INVENTION

Slurries or suspensions comprising liquids carrying suspended particles are typically subjected to a process called clarification or thickening to separate suspended particles from supernatant liquid. Typically, clarification and thickening are accomplished by continuously feeding an influent slurry or suspension feed stream into a settling tank or thickener, where suspended particles are allowed to gravity settle and form a sludge or thickened mud on the bottom of the tank. The thickened material is removed and further processed or disposed of, while the clarified liquid supernatant is either discharged, reused, or subjected to further clarification.

A feedwell (or feedwell assembly) is often used to introduce an influent feed stream flow into the settling tank or basin, as well as to provide a means of flocculating the feed stream and of distributing the feed stream into the tank in a nonturbulent manner. Disruption of the thickened material in the tank is minimized if the flow velocity of the influent feed stream is reduced before the influent enters to the tank. Typically, a feedwell dissipates the flow velocity by directing the feed stream into a circular or rectangular compartment in the center of the settling tank or basin which is separated from the contents of the settling tank or basin. The compartment is frequently mounted on a tower, column or pier in the center of the tank, but may be positioned around the perimeter of the tank or across the diameter of the tank.

As the influent feed stream flows into the channel, much of the kinetic energy of the stream is dissipated due to the reduction in velocity head and the friction of the influent with the channel floor and walls. The feedwell may also contain a series of baffles to help dissipate the kinetic energy of the influent feed stream. The relatively quiescent influent is then allowed to enter the settling tank through ports in the sides or through an open bottom of the feedwell, or by allowing it to spill over the edge of the channel or from an influent weir into the settling tank.

The sedimentation process is expedited by adding a flocculating reagent to the influent before it enters the settling tank. The flocculating reagent typically has a polymeric molecular structure which agglomerates with suspended particles in the influent to form aggregate clusters called flocs. Flocs have a greater size than the discrete suspended particles, and settle to the floor of the tank in a more celeritous manner.

Several factors influence the effectiveness of flocculating reagents to agglomerate with suspended particles. The flocculating reagent must be mixed thoroughly with the influent and allowed ample time to agglomerate. If the concentration of suspended particles in the influent is low, the flocculating reagent may need to be stirred through the influent. This requires the addition of a stirring mechanism or flocculator to the settling tank. If the concentration of particles is high, the influent may need to be diluted for optimum flocculation to occur. Typically as more of the flocculating reagent is added, the aggregate size is increased and vice versa. Larger aggregate size improves the clarification and thickening performance. As the reagent is an expense controlling the dosage rate is an important consideration.

The present invention obviates many of the problems and expenses associated with prior art methodologies for controlling the flocculent addition rate by providing a method and system for performing aggregate size analysis in a feedwell assembly, and which also facilitates feedwell design optimization via actual measurements of flocculant particle size (or floc size).

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

In accordance with an exemplary embodiment, a system for performing in-situ aggregate size analysis in a feedwell assembly comprises: a feedwell assembly, which receives an influent feed stream from at least one feed pipe; at least one flocculant feed pipe within the influent feed stream and/or feedwell assembly, which delivers a flocculant to the feed stream; an in-situ device, which provides images of flocculated particles within the feedwell assembly; and an image analysis software application, which receives the images of the flocculated particles within the feedwell assembly and provides for size measurement and averaging for dosage control of the flocculant added to the influent feed stream within the feedwell assembly.

In accordance with another exemplary embodiment, a method of performing in-situ aggregate size analysis in a feedwell assembly comprises: directing an influent feed stream from at least one feed pipe into a feedwell assembly; delivering a flocculant to the feedwell assembly via at least one flocculant feed pipe within the feedwell assembly; providing images of flocculated particles within the feedwell assembly to an image analysis software application; and performing thickener flocculant control based on the images of the flocculated particles obtained from within the feedwell assembly.

### BRIEF DESCRIPTION OF THE DRAWING

The above and other objects, features, and advantages will become more readily apparent from the following description, reference being made to the accompanying drawing in which:

FIG. 1 is a vertical sectional view of a thickener/clarifier tank having a center pier supporting a rotating sludge raking structure and a feedwell assembly with an in-situ device or apparatus for in-situ aggregate size analysis in accordance with the present invention.

FIG. 2 is a plan view of the thickener/clarifier tank of FIG. 1, taken on line II-II in FIG. 1.

FIG. 3 is a plan view of a feedwell system having an in-situ device or apparatus for in-situ aggregate size analysis in a feedwell in accordance with an exemplary embodiment.

FIG. 4 is a perspective view of an in-situ device or apparatus in the form of a digital camera and light source or lamp for aggregate size analysis in accordance with an exemplary embodiment.

FIG. 5 is a flow chart of a method of performing in-situ aggregate size analysis in a feedwell assembly in accordance with an exemplary embodiment.

### DETAILED DESCRIPTION

It can be appreciated that thickener/clarifier tanks are used in a wide variety of industries to separate influent feed slurry comprising a solids- or particulate-containing fluid to produce a “clarified” liquid phase having a lower concentration of solids than the influent feed slurry (or influent stream) and a “thickened” underflow stream having a higher concentration of solids than the influent feed slurry.

In accordance with an exemplary embodiment, the invention relates to a system and process (or method) for dosage control of the flocculant added to the influent stream (i.e., solution) contained within a feedwell (or feedwell assembly). It can be appreciated that in order to determine the amount of flocculant that must be added to the feedwell to obtain the optimal aggregated size, a system and method to continuously monitor flocculant particle size is valuable. The present invention provides a method of monitoring the content of the feedwell through the use of a submersible video camera. The submersible video camera provides a constant image (i.e., streaming image) from which the size of the aggregate within the feedwell can be determined. Through the use of image analysis software, the streaming images (and/or continuous images) provided by the submersible camera can be used to control the optimum dosage of flocculant (or flocculant reagent) added into the feedwell.

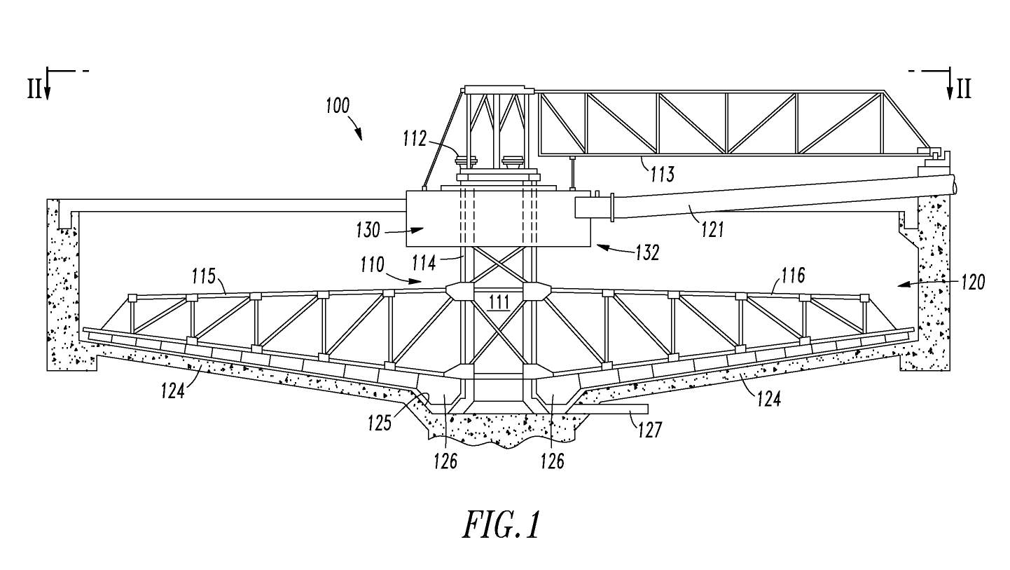

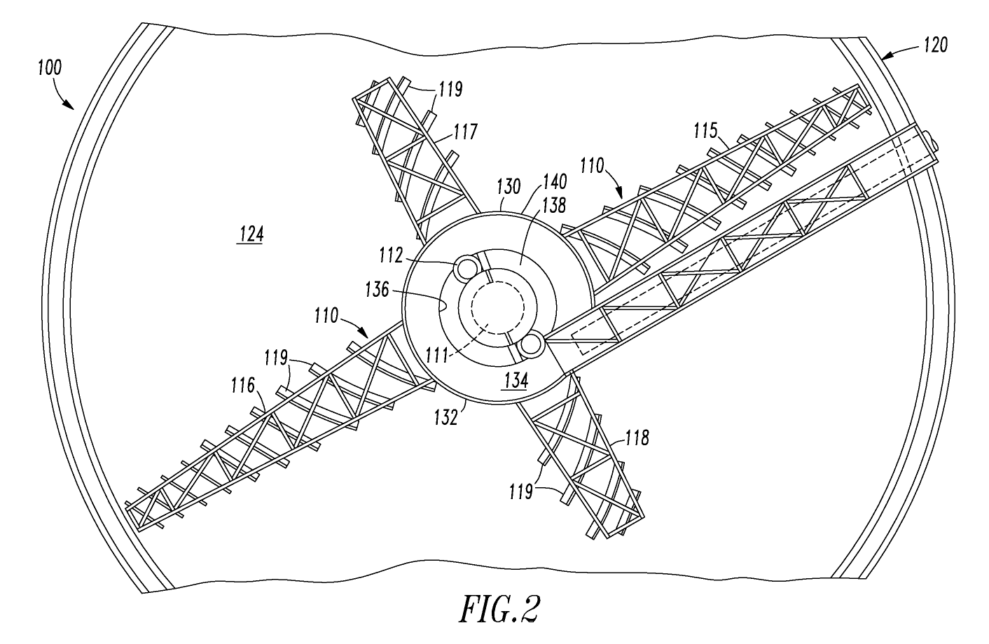

As shown in FIGS. 1 and 2, a thickener/clarifier 100 comprises a continuously operating thickening tank wherein a sludge raking structure 110 is supported for rotation upon a center pier 111, or from a bridge drive (not shown). A drive mechanism 112 of any suitable known construction is mounted atop the pier, or from a bridge, providing the driving torque for the rake structure. In this particular embodiment, the pier also supports the inner end of an access bridge 113, while some thickener mechanisms are bridge mounted.

Rake structure 110 comprises a central vertical cage portion or cage 114 surrounding the pier, and rake arms of girder like construction extending rigidly from the cage. Rake structure 110 has one pair of long rake arms 115 and 116 opposite to one another, and, if required, a pair of short rake arms 117 and 118 disposed at right angles thereto, all arms having sludge impelling or conveying blades 119 fixed to the underside thereof.

Rake structure 110 operates in a settling tank 120 to which a feed suspension or influent feed stream or pulp is supplied through feed pipe or infeed conduit 121 terminating in a feedwell assembly 130, which includes cylindrical feedwell body 132 which surrounds the top end portion of the rake structure and is supported by pier 111.

The tank 120 may be of usual construction, comprising a bottom 124 of shallow inverted conical inclination, and formed with an annular sump 125 around the pier, to which settled solids or sludge are conveyed by rake structure 110. Scraper blades 126, unitary with rake structure 110 and substantially conforming to the profile of sump 125, move the collected sludge to a point of delivery from the sump, as by way of a discharge pipe 127.

The feed pipe or infeed conduit 121 is connected at a downstream end to feedwell body 132. The infeed conduit 121 may also include a pumping and/or mixing assist assembly, variously located in the infeed conduit 121, which assembly may or may not be in open communication with the surrounding liquid volume inside the thickener tank 120.

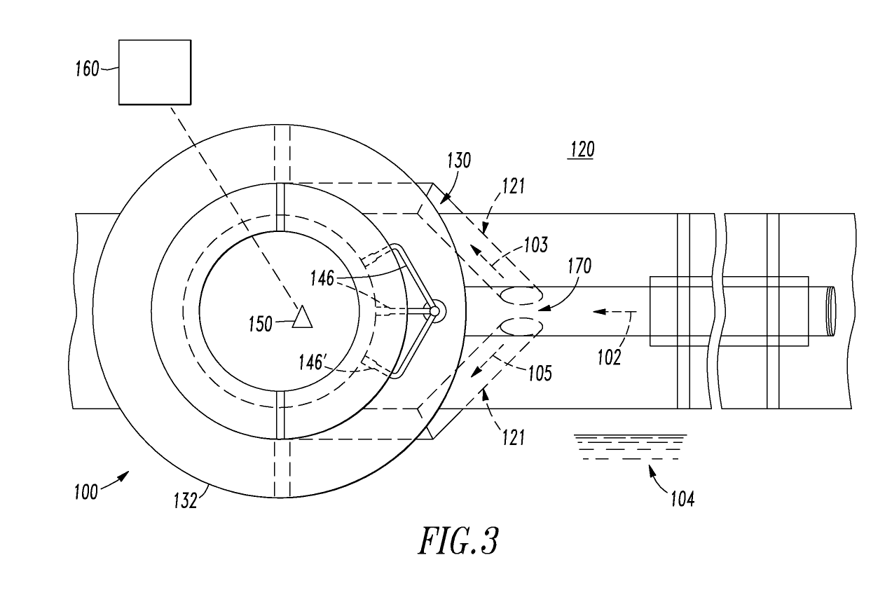

The feedwell body 132 has an annular floor panel 134 with an inner edge 136 defining a circular opening 138 and an outer edge contiguous with a cylindrical sidewall 140 of the feedwell body 132. The feed pipe or infeed conduit 121 is connected to feedwell body 132 so as to deliver an influent feed stream or slurry stream 102 to flow along a circular path inside the feedwell body. The influent feed stream or slurry stream 102 has a substantially circular inner boundary located generally above the inner edge 136 and a substantially circular outer boundary located adjacent feedwell sidewall 140. The inner and outer boundaries extend parallel to the path of the feed stream or slurry stream 102. The extended residence time in the feedwell body 132 increases the degree of mixing of a flocculent with the feed stream or slurry stream 102, the flocculent being delivered via at least one flocculant feed pipe (or ports) 146 (FIG. 3) communicating with infeed conduit 121 and/or feedwell body 132.

In accordance with an exemplary embodiment as shown in FIG. 3, a system for diluting an influent feed stream operates by introducing an influent feed stream into the volume of the tank 120 (FIG. 1) where the influent is retained for a period long enough to permit the solids to settle out by gravity from the fluid. The solids that settle to the bottom of the tank 120 produce a sludge bed near the bottom of the tank, which is removed through the underflow outlet. A clarified liquid is formed at or near the top of the thickener/clarifier tank and is directed away from the tank for further processing or disposal. Settling of solids may be enhanced in some applications by the addition of a flocculent or polymer that forms agglomerates that settle more readily. In many applications, an objective of fluid clarification is to enhance the settling process to achieve a high throughput of solids, and thereby enhance solids recovery.

In accordance with an exemplary embodiment, as shown in FIG. 3, the system also includes at least one flocculant feed pipe 146, and more preferably a triumvirate of flocculent feed pipes 146 extending inwardly to the feedwell body 132. The at least one flocculant feed pipe 146 delivers a flocculating reagent to the influent stream before it enters the settling tank. In accordance with an exemplary embodiment, the at least one flocculant feed pipe 146 is preferably positioned within the feed stream or feedwell assembly 130. The flocculating reagent has a polymeric molecular structure which agglomerates with suspended particles in the influent to form aggregate clusters or flocs. As set forth above, flocs have a greater size than the discrete suspended particles, and settles to the floor of the tank in a more celeritous manner.

As shown in FIG. 3, the system also includes an in-situ device or apparatus 150, which provides flocculant control by in-situ size analysis. In accordance with an exemplary embodiment, the in-situ device or apparatus is a submersible digital video camera, which provides streaming images (and/or continuous images) of flocculated particles within the feedwell assembly 130 to an analysis software application 160, which receives the streaming images and provides the operator feedback on the flocculant particle size, including chord length, and average and/or median size of the flocculant particles (or flocs).

As shown in FIG. 3, the influent feed stream or slurry stream 102 is supplied to a directional nozzle 170 which splits the feed stream 102 into two feed streams 103, 105 flowing in opposing directions into the feedwell (or feedwell assembly) 130. The two feed streams 103, 105 are directed into duplicate but contrapositioned eduction zones of the feedwell 130.

It can be appreciated that in accordance with an exemplary embodiment, the feed pipes 121 are eductor assemblies (not shown), which include an upstream feed pipe portion (or inlet portion), which converge to a narrow throat portion on a downstream end thereof and having one or having one or more ports or nozzles, and a mix tube (or receiving chamber) having an inlet portion, which is positioned downstream of the narrow throat portion to provide mixing of the influent feed stream 102 and a clarified liquid (or dilution liquid) 104 drawn from the settling tank 120.

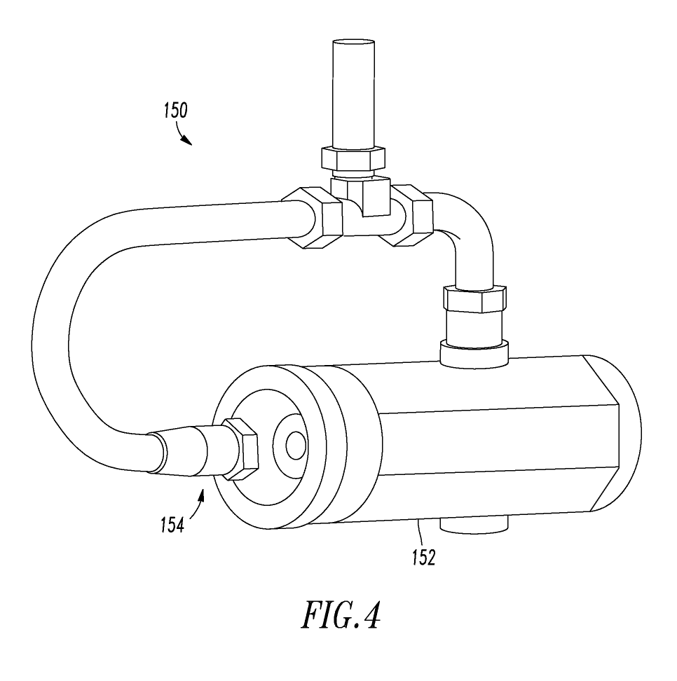

FIG. 4 is a schematic view of an in-situ device 150 (or floc-cam) for aggregate size analysis in the feedwell or feedwell assembly 130. As shown in FIG. 4, in accordance with an exemplary embodiment, the in-situ device or apparatus 150 is a commercially available digital video camera 152. The in-situ device or apparatus 150 also preferably includes a light or illumination source (i.e., lamp) 154, which provides a source of light or illumination to assist with the visualization of the flocculant particles within the feedwell 130. In accordance with an exemplary embodiment, the digital video camera and light source or lamp is an Immersion Turbity/Color Analysis/Percent solid Analyzer™ manufactured and sold by J.M. Canty®. However, it can be appreciated that any suitable in-situ device or apparatus can be used, including other types of motion detection devices such as fiber optics or an optical transmission system. In accordance with an exemplary embodiment, a water jet or mechanical arm can be used to clean the lens (or lenses) and/or the light source associated with the in-situ device 150 (and/or submersible video camera 152).

In accordance with an exemplary embodiment, the in-situ device or apparatus 150 captures streaming images (i.e., images), which are provided to an image analysis software application 160 (or particle analysis software application), which provides feedback on the flocculant particle size in real time within the feedwell. In addition, through the image analysis software application 160, the streaming images can be used to control the optimum and/or desired dosage of flocculant (or flocculant reagent) added into the feedwell.

In accordance with an exemplary embodiment, the particle analysis software 160 can be a commercially available particle size analysis software application that enables a user to study the dynamics of the flocculant particles within the feedwell assembly 130. For example, in accordance with an exemplary embodiment, the particle analysis software is CantyVision Client Software™, which is manufactured and sold by J.M. Canty.

In accordance with an exemplary embodiment, image analysis software can be used to measure the size of the floc structures (i.e., flocculant particles) and determine an average and/or median size. It can be appreciated that the information obtained from the particle size analysis software can be used to control the flocculant addition rate to maintain a consistent floc size (i.e., flocculant particle size) as the concentration of the influent stream changes, including changes in ore and/or ore concentration, and/or feed rates of the influent feed stream. It can also be appreciated that the system and/or method provides faster response times to changes in conditions within the settling tank and the feedwell by obtaining an in-situ analysis of flocculant particle size within the feedwell assembly. In addition, this provides the operator the ability to accurately control the associated parameters within the feedwell system.

For example, in accordance with an exemplary embodiment, a particle size analysis of the flocculated particles within the feedwell assembly can be preformed to determine an average and/or median flocculant particle size, and using the average and/or median flocculant particle size, the software application and/or operator can determine an optimum dosage of flocculant, which needs to be added to the feedwell assembly to obtain a desired flocculated particle size (or floc size).

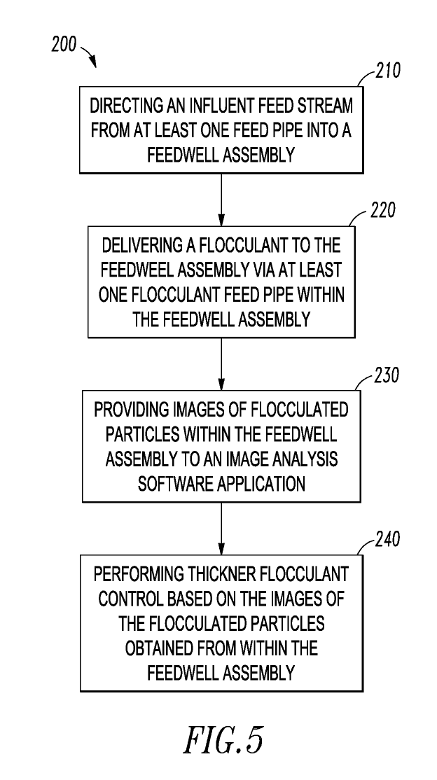

FIG. 5 is a flow chart of a method of performing in-situ aggregate size analysis in a feedwell assembly 200 in accordance with an exemplary embodiment. As shown in FIG. 5, the method of performing in-situ aggregate size analysis in a feedwell assembly 200 comprises the steps of directing an influent feed stream from at least one feed pipe into a feedwell assembly 210; delivering a flocculant to the feedwell assembly via at least one flocculant feed pipe within the feedwell assembly 220; providing images of flocculated particles within the feedwell assembly to an image analysis software application 230; and performing thickener flocculant control based on the images of the flocculated particles obtained from within the feedwell assembly 240.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A system for performing in-situ aggregate size analysis in a feedwell assembly comprising:
a feedwell assembly, which receives an influent feed stream from at least one feed pipe;
at least one flocculant feed pipe within the feed stream and/or feedwell assembly, which delivers a flocculant to the feed stream;
an in-situ device, which provides images of flocculated particles within the feedwell assembly; and
an image analysis software application, which receives the images of the flocculated particles within the feedwell assembly and provides for size measurement and averaging for dosage control of the flocculant added to the influent feed stream within the feedwell assembly.

2. The system of claim 1, wherein the in-situ device is a submersible video camera.

3. The system of claim 2, wherein the in-situ device further includes an illumination source.

4. The system of claim 2, wherein a fiber optic and/or optical transmission system is used in place of the submersible video camera.

5. The system of claim 1, wherein image analysis software application determines an average size of the flocculated particles, which is used to control an amount of flocculant delivered to the feedwell assembly.

6. The system of claim 5, wherein the image analysis software application also provides feedback for controlling the amount of flocculant delivered to the feedwell assembly so as to maintain a consistent floc size as changes in a composition of the influent feed stream and/or feed rate of the influent feed stream occurs.

7. The system of claim 1, wherein the in-situ device captures the images in real time.

8. The system of claim 1, wherein the image analysis software application performs a particle size analysis of the flocculated particles within the feedwell assembly.

9. The system of claim 1, wherein the at least one feed pipe comprises two feed pipes, which dissipate a flow velocity by directing the influent feed stream into the feedwell assembly, which is in a center portion of a settling tank.

10. The system of claim 1, further comprising controlling a diluent to the influent feed stream within the feedwell assembly upon a determination that the feed concentration should be varied.

11. The system of claim 1, further comprising a directional nozzle, which directs the influent feed stream into at least one of two feed pipes, each feed pipe having an inlet positioned to receive the influent feed stream from the directional nozzle.

12. The system of claim 1, further comprising a water jet or mechanical arm, which is sized and configured to clean a lens and/or a light source of the in-situ device.

13. A method of performing in-situ aggregate size analysis in a feedwell assembly comprising:
directing an influent feed stream from at least one feed pipe into a feedwell assembly;
delivering a flocculant to the feed stream or feedwell assembly via at least one flocculant feed pipe;
providing images of flocculated particles within the feedwell assembly to an image analysis software application; and
performing thickener flocculant control based on the images of the flocculated particles obtained from within the feedwell assembly.

14. The method of claim 13, wherein the images received from within the feedwell assembly are obtained via a video camera submersed within the feedwell assembly.

15. The method of claim 14, wherein the submersed video camera captures the images in real time.

16. The method of claim 13, further comprising:
measuring a size of the flocculated particles within the feedwell assembly;
determining an average size of the flocculated particles within the feedwell assembly; and
controlling the amount of flocculant delivered to the feedwell assembly so as to maintain a consistent flocculant particle size.

17. The method of claim 16, further comprising controlling the amount of flocculant delivered to the feedwell assembly so as to maintain a consistent flocculant particle size as changes in composition of the influent feed stream and/or feed rate of the influent feed stream occurs.

18. The method of claim 17, further comprising performing a particle size analysis of the flocculated particles within the feedwell assembly to determine an average and/or median flocculant particle size, and using the average and/or median flocculant particle size to determine an optimum dosage of flocculant, which needs to be added to the feedwell assembly to obtain a desired flocculated particle size.
